(19) United States
(12) Patent Application Publication
(10) Pub. No.: US 2004/0042591 A1
(43) Pub. Date: Mar. 4, 2004

(54) Method and system for the processing of voice information

(76) Inventors: Nicholas Andre Geppert, St. Leon-Rot (DE); Jurgen Sattler, Wiesloch (DE)

Correspondence Address: Finnegan, Henderson, Farabow,, Garrett & Dunner, L.L.P., 1300 I Street, N.W., Washington, DC, 20005-3315, US

(21) Appl. No.: 10/430,439

(22) Filed: May 7, 2003

(30) Foreign Application Priority Data
May 8, 2002 (DE) 102 20 519.1

(51) Int. Cl. H04M 1/64; H04M 11/00

(52) U.S. Cl. 379/88.01; 379/88.14; 379/88.18

(57) ABSTRACT

Methods and systems are provided for processing voice data from a call between a first human party and a second or more human parties. The call may be analyzed either fully or in part with an automated voice recognition system to convert spoken comments into text automatically. The results of voice recognition may be provided to at least one of the second human parties either fully or in part. Further, in one embodiment, the automated voice recognition system is linkable to at least one of a database system and an expert system.

### FIELD OF THE INVENTION

The present invention relates to methods and systems for the automated handling of voice information from a call between a first human party and one or more second human parties.

### BACKGROUND INFORMATION

Automated voice recognition has been used in practice for some time and is used for the machine translation of spoken language into written text.

According to the space/time link between voice recording and voice processing, voice recognition systems can be divided into the following two categories:

“Online recognizers” are voice recognition systems that translate spoken comments directly into written text. This includes most office dictation machines; and

“Offline recognition systems” execute time-delayed voice recognition for the recording of a dictation made by the user with a digital recording device, for example.

The state of the art voice processing systems known to date are not able to understand language contents, i.e., unlike human language comprehension, they cannot establish intelligent a priori hypotheses about what was said. Instead, the acoustic recognition process is supported with the use of text- or application-specific hypotheses. The following hypotheses or recognition modes have been widely used to date:

Dictation and/or vocabulary recognition uses a linking of domain-specific word statistics and vocabulary. Dictation and/or vocabulary recognition is used in office dictation systems;

Grammar recognition is based on an application-specific designed system of rules and integrates expected sentence construction plans with the use of variables; and

Single word recognition and/or keyword spotting is used when voice data to support recognition are lacking and when particular or specific key words are anticipated within longer voice passages.

A voice recognition system for handling spoken information exchanged between a human party and an automated attendant system is known, for example, from the document “Spoken Language Systems—Beyond Prompt and Response” (BT Technol. J., Vol. 14, No. 1, January 1996). The document discloses a method and a system for interactive communication between a human party and an automated attendant system. The system has a voice recognition capability that converts a spoken comment into a single word or several words or phrases. Furthermore, there is a meaning extraction step, where a meaning is attributed to the recognized word order, with the call being forwarded by the automated attendant system to a next step based on said meaning. By means of a database search, additional information can be obtained for a recognized word. Based on the recognized and determined information, a response is generated, which is transformed into spoken language by means of a voice synthesizer and forwarded to the human party. If the human party communicates with the automated attendant system through a multi-modal system, (e.g., an Internet, personal computer with voice connection), it can be provided with information determined by the automated attendant system visually on the screen and/or acoustically through the microphone of the personal computer and/or headsets. For further details, reference is made to the aforementioned document and the secondary literature cited therein.

Another voice recognition system is known from DE 197 03 373 A1. This document discloses a communication system for the hearing impaired and, in particular, a telephone system or accessories for equipping a phone system for the needs of the hearing impaired. The system includes a voice recognition unit which is capable of converting signals received over a phone network and through a phone into a computer-readable code, especially voice signals in the corresponding ASCII-text, which can be reproduced as text on an output device, such as a monitor or display.

Despite this high degree of automation, such voice recognition systems are problematic especially with respect to the recognition of the voice information unless the voice recognition system was adjusted to the specific pronunciation of a person in the scope of a learning phase because pronunciation differs from person to person. Especially automated attendant systems, where one party requests information or provides information, are not yet practicable because of the high error rate during the voice recognition process and the various reactions of the individual parties. Thus, many applications still require the use of a second party rather than an automated attendant system to take the information provided by the first party or give out information. If the second party receives information, the information—regardless of form—usually must be recorded, written down, or entered into a computer. This does not only require a high personnel effort, but is also time-consuming, thus making the call throughput less than optimal.

### SUMMARY OF THE INVENTION

The present invention is therefore based on the problem to provide methods and systems for optimizing the call throughput of calls between a first party and at least one second human party.

In accordance with an embodiment of the invention, a method is provided for processing voice information from a call between a first human party and one or more second human parties. The method comprises: analyzing the call either fully or in part with an automated voice recognition system to convert spoken comments into text automatically; and providing the results of voice recognition to at least one of the second human parties either fully or in part, wherein the automated voice recognition system is linkable to at least one of a database system and an expert system.

In accordance with another embodiment of the invention, a system is provided for processing voice information. The system comprises: at least one electronic device for the recognition and extraction of voice data (e.g., a voice recognition system), which can be connected to one or a plurality of devices for the recording of voice data (e.g., an automated attendant system); and, one or a plurality of means for the representation and/or storage of recognized and/or extracted voice data, with the one or any plurality of means for the representation and/or storage being directly or indirectly connected to the recognition and extraction device.

“Direct” in this context means that the connection is established directly through, for example, a cable, a wire, etc. “Indirect” in this context means that the connection is established indirectly through, for example, wireless access to the Internet, a radio- or infrared-connection, etc.

According to yet another embodiment of the invention, a computer program is provided with program code means to execute all steps of any of the methods of the invention when the program is executed on a computer, as well as a computer program product that comprises a program of this type in a computer-readable storage medium, as well as a computer with a volatile or non-volatile memory where a program of this type is stored.

Preferred and other embodiments of the present invention will be apparent from the following description and accompanying drawings.

It is to be understood that both the foregoing general description and the following detailed description are exemplary and explanatory only, and should not be considered restrictive of the scope of the invention, as described. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this specification, illustrate various embodiments and aspects of the present invention. In the drawings:

FIG. 1 is a schematic representation of a first configuration to execute a method, in accordance with an embodiment of the invention;

FIG. 2 is a schematic representation of a second configuration to execute a method, in accordance with another embodiment of the invention;

FIG. 3 a schematic representation of an exemplary voice recognition system, in accordance with an embodiment of the invention; and

FIG. 4 a schematic representation of another configuration to execute a method, in accordance with an embodiment of the invention.

### DETAILED DESCRIPTION

In accordance with an embodiment of the invention, it is provided that a voice recognition system and/or a voice recognition process is linked to a database system, such as R/3® (SAP Aktiengesellschaft, 69190 Walldorf, Germany) and/or an expert system. In this way, the results or the partial results of the voice recognition process can be entered directly into a database and/or an expert system. Furthermore, information from the database and/or expert system can be used to support the voice recognition process, for example for vocabulary dynamization. Thus, additional information can be extracted through the link, which—as already indicated—can be used for voice recognition.

The information obtained from the database and/or expert system can be used to control the dynamic recognition process of the voice recognition. For example, information about a party stored in a database and/or R/3® system can be used to control the voice recognition of the voice data available for the party such that the voice recognition is based on vocabulary that had already been used in earlier calls with the party. The voice data recognized during the current call can also be stored into the database and/or R/3® system or in an appropriate database and—already during the call—dynamically increase the vocabulary resource for the party during the voice recognition while the call is in progress.

Embodiments of the invention can also provide the advantage of less memory space being required for the recording of calls in a storage medium for data processing systems than if the call were recorded acoustically, for example as a “wavfile.” If a call were to be stored as a file of this type, approximately 8 megabytes would be required per minute of call. If the call is converted into text in accordance with embodiments of the invention and then stored, the same call would require only a few kilobytes.

It is known that automated attendant systems can be used if the expected flow of information of a call is largely predetermined, i.e., if one party, for example, will give the automated attendant system an answer to a question—such as yes or no, a number between one and five, etc. In that case, the voice recognition system can recognize the voice data with a high degree of success and the appropriate information can be stored for further processing.

For more complex calls, it was found in accordance with embodiments of the invention that instead of an automated attendant system, a second party is required to guarantee an exchange of information that is not distorted by error-prone voice recognition systems. To that end, however, the second party is provided with assistance to help with and/or avoid the tedious and time-consuming entering or recording of data. For that purpose, the voice data of the call between the first party and the second or any other party are forwarded to a voice recognition system. It is also conceivable that only the voice data of the first party are forwarded to the voice recognition system. The voice recognition system then executes the voice recognition for a subset of the voice data such as, for example, the voice data of only one party, and/or very generally for all voice data. Even if the voice recognition is only partially successful, the extracted information can be provided to a party. In this way, at least simple data such as numbers or brief answers to questions can be recognized by the voice recognition system without error and are then available to the party in a storable format.

However, for more complex calls, the call can be accepted first by an automated attendant system, which will forward the call to one party or to any second party or add the second party by switching. The call also can be established by the automated attendant system in that the system is set in such a way that it dials people based on a predefined list (such as a phone book) automatically by phone and then adds one or any second party by switching, or forwards the call to the second party. In this way, for example, simple opinion polls could be prepared automatically.

In one embodiment of the invention, the voice recognition system is preferably integrated into the automated attendant system.

In another embodiment of the invention, the information obtained through voice recognition is stored such that it can be provided for statistical evaluation at a later time, for example.

If an automated attendant system is used, the automated attendant system may be implemented or work as an “Interactive Voice Response System” (IVRS). An IVRS system of this type is capable of communicating with a party—albeit within a limited scope—and reacting depending on the voice input from the party. Preferably, an automated IVRS system is provided to implement embodiments of the invention.

A high recognition rate can be achieved in an especially advantageous manner if the party whose voice data are to be analyzed is confronted with standard call structures. This could be declarations and/or questions by the automated attendant system and/or a party, which are already known to the voice recognition system in this form. The party confronted with the targeted questions and/or standard call structures will then most likely generally react “as anticipated”, and the information contained in this expected reaction can be correctly recognized with a high degree of probability and extracted and/or stored accordingly. To that end, a method of grammar recognition could be used in a particularly advantageous manner for the voice recognition.

For the practical realization of an automated attendant system and/or a voice recognition system, at least one computer may be used. The same computer can be used for the automated attendant system and the voice recognition system. However, a preferred embodiment provides that only one computer is used as an automated attendant system. The voice data of the call are then forwarded to another computer, where the voice recognition system is implemented. This computer should have sufficient performance data or characteristics. In addition, a computer used as an automated attendant system may include an interface to establish a phone and/or video connection. Another interface can also be provided for the input and output of the voice and/or video data.

The voice recognition itself could be executed on one computer or a plurality of computers. Especially with time-sensitive applications, the voice recognition is preferably executed in parallel on a plurality of computers. Thus, the voice recognition process could be divided into a plurality of partial processes, for example, with each partial process being executed on a computer. In the division into partial processes, individual sentences or clauses could be assigned to each partial process, and a timed division of the voice data—for example into time intervals of 5 seconds each—is also conceivable. If the computer has a plurality of processors (CPUs), the partial processes could be distributed to the processors of the computer and executed in parallel.

If the computing performance of a single computer is not sufficient for the voice recognition and/or for the automated attendant system, a computer network system could be provided to execute these processes in parallel on a plurality of computers. In particular, individual computers of a network system could execute specific, varying voice recognition modes so that each computer analyzes the same voice data under a different aspect.

In a preferred embodiment of the invention, the voice data of the call are stored at least largely unchanged. The storing into memory could comprise all voice data of the call. For example, if a caller or the automated attendant system uses standard call structures that are known to the voice recognition system, only the voice data of the other party could be stored. Principally, the memory process provides for the storing of markers such as bookmarks in addition to the voice data, thus giving the call to be stored a coherent or logical subdivision. This subdivision can be used to accelerate or simplify the process of extracting information in a subsequent voice data recognition.

In another embodiment of the invention, information about the current status of the call can be taken into account in the voice recognition. For example, at the beginning of the call, the fact could be taken into account that both the caller and the called party will identify one another, and a voice recognition will employ the appropriate vocabulary and/or grammatical recognition modes for this purpose. This information about the current status of the call, regardless of how it is obtained, could also be stored together with the voice data.

In the evaluation of voice data recorded by an automated attendant system, voice recognition could be tailored specifically to a request for analysis. For example, a poll of viewers or a quiz of listeners of a T.V. or radio show could be analyzed automatically so as to determine which political measures, for example, find the greatest acceptance among the viewers or listeners. The request for analysis, for example, could be to determine whether measure A or measure B is preferred, so that the information and the knowledge of the possible variants of the poll is taken into account in the voice recognition and/or provided to the voice recognition as additional information.

If the voice data comes from a call between two parties, the voice recognition may preferably be tailored specifically to a request for analysis. Such a request for analysis could comprise, for example, mainly the voice recognition of the voice data of one of the parties, with the analysis being tailored, for example, specifically to the recognition of the phone number of the one party, etc.

Methods that may be provided for voice recognition include dictation, grammar, or single word identification and/or keyword spotting. This could include, for example, making a switch from one voice recognition method to the other voice recognition method depending on the current call situation if it is foreseeable that another voice recognition method promises better results for the voice recognition of the current call situation. Preferably, the various methods of voice recognition can also be employed in parallel, which is executed, for example, with parallel distribution to a plurality of computers.

In a preferred embodiment, repeated execution of the voice recognition is provided. To that end, it is possible to forward the voice data and/or the at least largely unchanged stored voice data of a call repeatedly to the same or different voice recognition processes. Repeated voice recognition may be implemented with an offline recognition system, because this allows a time delay of the voice recognition.

Another voice recognition strategy provides for performing a dynamic adjustment of the voice recognition. For example, the vocabulary for the voice recognition could be varied and/or adjusted. An initially employed voice recognition method—for example the dictation recognition—may result in a low recognition rate, making it obvious that maintaining the dictation recognition would only have a limited promise of success. It is then provided to dynamically employ another voice recognition method, with the recognition rate of the newly employed voice recognition method also being analyzed immediately, and another dynamic voice recognition step following thereafter, if necessary. It may also be provided to apply the same voice recognition method to the voice data in parallel on a plurality of computers, but using a different vocabulary for the voice recognition on each of the computers. An immediate analysis of the recognition rate of these parallel running voice recognition processes may lead to a dynamic adjustment and/or control of the further voice recognition.

In addition or alternately, another preferred procedure step is provided, which can be summarized under the preamble “vocabulary dynamization.” This includes the repeated analyses of the voice data. In a first recognition step, the voice data are classified. This could be done using one or more of the keyword spotting methods, for example. Depending on the result of the voice data classification, the voice data are again analyzed in another recognition step after adding special vocabulary. This recognition process is based on a vocabulary that is directly or closely related to the result of the voice data classification step. It is entirely conceivable that the recognition step of the voice data is based on a vocabulary from a plurality of specific areas. The additional recognition step is preferably applied to the original voice data, but it is possible to include the information obtained in the first recognition step. Accordingly, the procedure steps of the vocabulary dynamization are applied over and over again to the original voice data.

In embodiments of the invention, other recognition steps may be executed iteratively and will lead, in the ideal case, to a complete recognition of the entire voice data or at least a subset of the voice data. The further iterative recognition steps are preferably controlled by recognition probabilities, thus providing discontinuation criteria, for example, once the recognition probability no longer changes.

It is principally provided to store especially the information obtained in the voice recognition. In a preferred embodiment, it is additionally or alternately provided to provide information in the form of a graphical and/or orthographical representation. This may be provided for information that may be time-delayed and originated in a call recorded with an automated attendant system. This may also be applicable, however, to information from the voice recognition of call data that originated in a call between two or more parties. In this way, either all information concerning the call, i.e., literally every word, or only extracted and/or selected information from the call, which is useful for the respective application of methods in accordance with embodiments of the invention, may be displayed. The information may be provided on the output unit of a computer, such as a monitor, on a screen, or on a television. The output of information on a cell phone display may also be provided.

In general, information may be provided with time delay. This will be the case especially for call information that originated with an automated attendant system, i.e., where a synchronous voice recognition and/or information analysis is not necessary. Alternately, it is provided in a preferred manner to recognize the information nearly synchronously, i.e., “online” and/or provide it to the other party. This is the case in particular when voice data of a call between two parties are recognized and/or analyzed. The information can be provided either to one or both and/or all parties, depending on the objective of the application of methods in accordance with embodiments of the invention. Providing the information online, however, could also be effected in connection with an automated attendant system, for example, during a radio or T.V. show if a “live poll” must be analyzed within a short time.

The party to whom the information is provided during the call (the other party or any second party) could then at least partially direct, control and/or steer the voice recognition. For this purpose, appropriate symbols may be provided on the graphical user surface of a corresponding computer and/or control computer, which have varying effects on the voice recognition and can be operated simply and quickly by the called party. In particular, it may be provided that the called party can operate appropriate symbols that classify and/or select a plurality of results coming from the voice recognition system as correct or false. Finally, one of the parties can train the recognition system to the voice of the other party so that the voice recognition system can at least largely recognize the voice data of the other party during a longer call. Furthermore, appropriate symbols can be provided, which result in an acceptance or rejection of the information to be stored as a result of the voice recognition.

Furthermore, it may be provided, for example, that the called party uses standard vocabulary for the voice recognition or the sequence of the application of the various voice recognition methods.

When the voice recognition system is linked to a database and/or expert system, it may be provided that a user profile for each party has been established or has already been stored. The user profile could be loaded automatically for the recognition of another call to the same party. In addition, it is also conceivable that the party to whom the information is provided loads the user profile. For the recognition mode of the voice recognition, a specific vocabulary resource, etc. can be stored in a user profile.

In accordance with another preferred embodiment, information may be extracted from the database and/or expert system and provided in addition to the extracted voice information. This plan of action could be used, for example, in a call center. Here, the party accepting the call, referred to as agent in the following, is the party to whom the extracted information is provided. In addition to the recognized and extracted information from the voice recognition process, the agent may also be provided with additional information, for example, about the caller, his/her field of activity, etc., so that the agent receives, in an especially advantageous manner, more information even before the call ends than was in fact exchanged during the call. This also allows the agent to address other subject areas that were not mentioned by the caller, thus giving the caller in an especially advantageous manner the feeling that the call center agent personally knows the caller and his/her field of activity. Proceeding in this way also allows providing the caller with a more intensive and/or effective consultation in an advantageous manner.

For the simple operation by a party, the appropriate output modules for the extracted information and/or the symbols for the control and/or steering of the voice recognition could be integrated into a total surface and/or in a total program of a computer program. In this way, a call center agent only needs to operate a central application and/or a central program, which also increases the efficiency of the total system.

In another advantageous manner, methods in accordance with embodiments of the invention may be used for training call center agents. For example, the agent could be trained in call strategy specifically on the basis of the information stored about a caller in a database and/or expert system. An objective could be, for example, that on the one hand, the call center agent learns how to conduct a successful sales talk with a caller and on the other hand, that the agent supplies to the total system or stores in the total system important data about the caller—information that had either already been stored or is obtained during the call—so that a call center agent can also be trained in speed during the course of a call.

In an especially advantageous manner, the voice recognition system may be trained to the voice of a party. In the case of a call center, this would be the call center agent, who interacts with the voice recognition system practically at every call. Thus, at least the voice data of one of the parties, i.e., the agent, may be recognized and/or analyzed at an optimized recognition rate. The recognition rate of the voice recognition system can be furthermore increased in an advantageous manner in that one party and/or the call center agent repeats particular words that are important to the other party and/or the agent. Thus, the voice recognition system can then properly recognize and/or analyze these words said by the party to whom the voice recognition system is trained with a high recognition rate.

There are various possibilities to configure and develop embodiments of the present invention in an advantageous manner. Reference to that effect is made on the one hand to what is claimed and on the other hand to the following explanation of exemplary embodiments of the invention by reference to the accompanying drawings. Embodiments of the invention, however, are not limited to these examples.

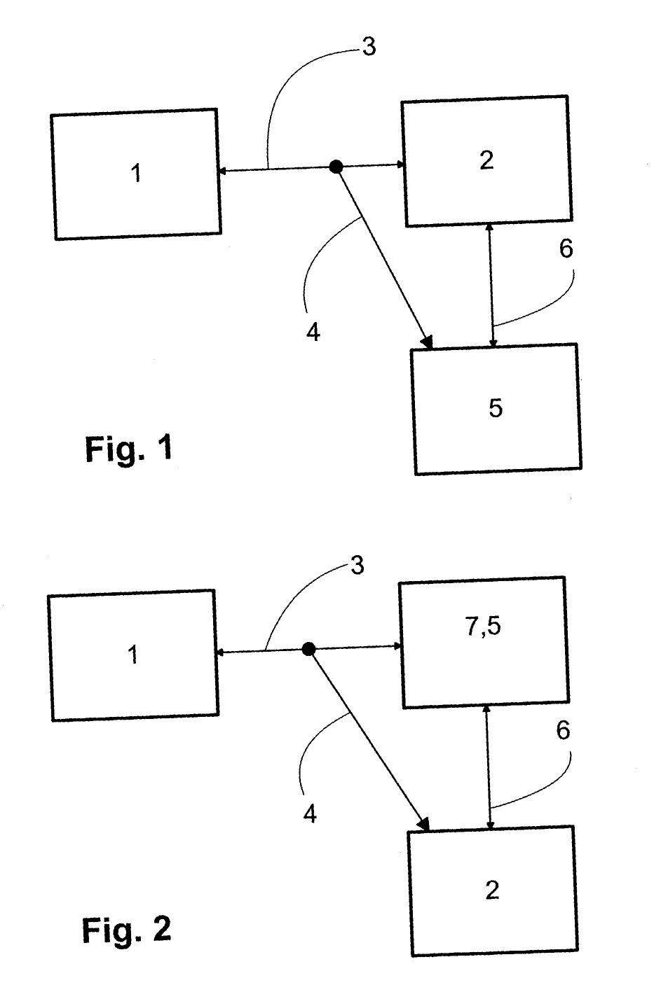

FIG. 1 shows schematically a first party 1 and a second party 2, with both parties 1, 2 being involved in a call, in accordance with an embodiment of the invention. The phone connection between parties 1, 2 is indicated with the reference symbol 3. A connection 4 forwards voice data of the call to a voice recognition system 5.

In accordance with an embodiment of the invention, at least a subset of the voice data is recognized and extracted. The result of the voice recognition is provided to the party 2 through a connection 6. The connection 6 can also be a visual connection to a monitor, for example.

FIG. 2 shows a configuration, in accordance with another embodiment of the invention, where a party 1 is involved or was involved in a call with an automated attendant system 7 through a phone connection 3, and the automated attendant system 7 forwarded the call to a second party 2. The automated attendant system 7 may be implemented as an automatic interactive voice response system. A voice recognition system 5, which provides voice recognition as well as the storing of voice data and the extraction of information from the voice data, is also provided in or with the automated attendant system 7. By way of example, automated attendant system 7 may comprise a computer or workstation.

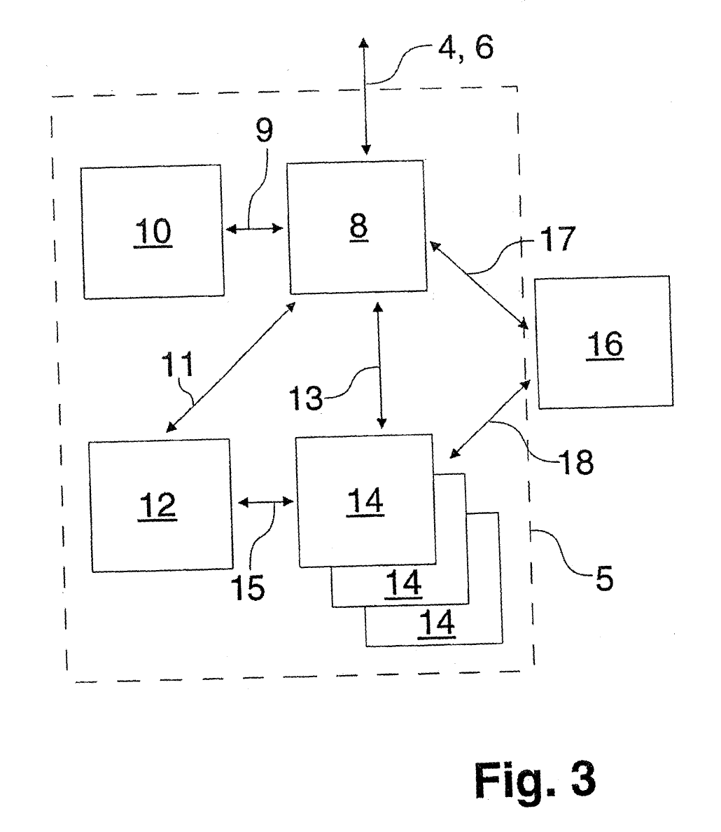

The voice recognition system 5 may be comprised of a plurality of computers, which is shown schematically in the example of FIG. 3. Specifically, it is a computer network system on which the voice recognition is executed in parallel. The voice data are forwarded through a connection 4 to the voice recognition system 5. The voice data are distributed over the network by an input/output server 8. In this way, the voice data are supplied through a connection 9 to a data memory 10. Furthermore, the voice data are supplied through connection 11 to a base form server 12 and through connection 13 to a plurality of recognition servers 14 (by way of example, three servers 14 are illustrated in FIG. 3). The base form server 12 provides the required phonetic pronunciation transcriptions. A voice data exchange between the base form server 12 and the three recognition servers 14 is also provided through the connection 15.

The voice recognition on the recognition servers 14 may be executed in parallel, e.g., one of the three recognition servers 14 executes a dictation recognition, the other recognition server 14 executes a grammar recognition and the third recognition server 14 executes a keyword spotting recognition. Accordingly, the three different voice recognition methods are employed quasi in parallel; because the various voice recognition methods require slightly different computing times, there is no synchronous paralleling in the strict sense.

If the voice recognition is executed repeatedly, the original voice data of the call, which were stored in the data memory 10, are requested by the input/output server 8 and again distributed to the base form server 12 and the recognition servers 14.

In an advantageous manner, the voice recognition system 5 as well as the voice recognition process may be linked to a database system 16 through the connections 17, 18. Through such link(s), additional information is extracted. The information about the party 1, which was stored in and is recalled from the database system 16, is used to support the voice recognition process. For this purpose, the recognition server 14 on which the dictation recognition is running is provided with a vocabulary that is stored in the database system 16 and was tied to the party 1 in the scope of a previous call.

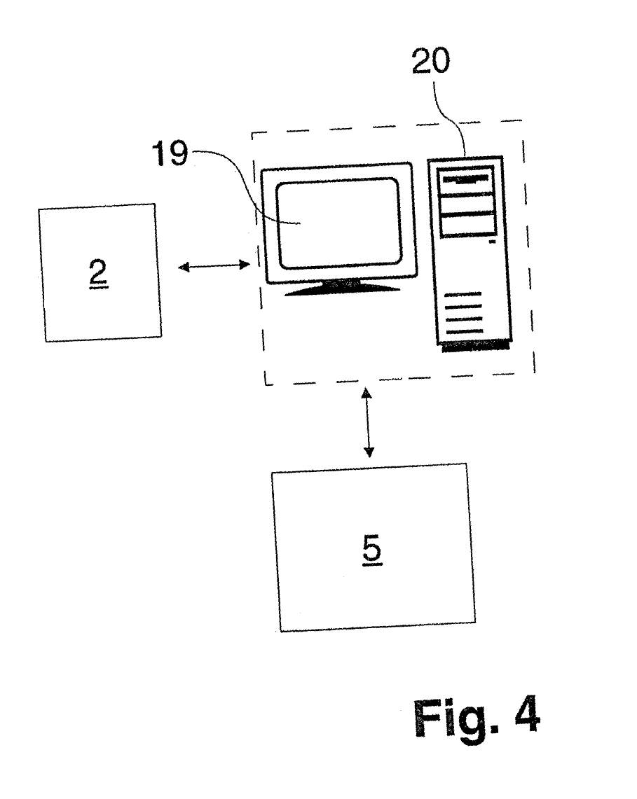

FIG. 4 shows schematically that party 2 may be provided with the information of the voice recognition system 5, including the information of the database system, in the form of a graphical and orthographical representation on a monitor 19 of a computer 20. The representation of the information may be effected during the call.

Party 2 can also interact in the voice recognition process through the computer 20 to control the voice recognition process such that an optimal voice recognition result can be obtained. The graphical as well as the orthographical representation of the extracted voice information as well as the control of the voice recognition process is executed with a user interface that is available to party 2 on the computer 20 including monitor 19. In this way, party 2, who is working for example as an agent in a call center, can provide the party 1 with an optimum consultation.

Other embodiments of the invention will be apparent to those skilled in the art from consideration of the specification and practice of the embodiments of the invention disclosed herein. In addition, the invention is not limited to the particulars of the embodiments disclosed herein. For example, the individual features of the disclosed embodiments may be combined or added to the features of other embodiments. In addition, the steps of the disclosed methods may be combined or modified without departing from the spirit of the invention claimed herein.

Accordingly, it is intended that the specification and embodiments disclosed herein be considered as exemplary only, with a true scope and spirit of the embodiments of the invention being indicated by the following claims.

What is claimed is:

1. A method for processing voice data from a call between a first human party and a second or more human parties, the method comprising:
analyzing the call either fully or in part with an automated voice recognition system to convert spoken comments into text automatically, the automated voice recognition system being linkable to at least one of a database system and an expert system; and
providing the results of voice recognition either fully or in part to at least one of the second human parties.

2. A method in accordance with claim 1, wherein the call is a phone call made by the first human party to the second human party.

3. A method in accordance with claim 2, further comprising accepting the phone call with an automated attendant system and forwarding the call with the automated attendant system to the second party.

4. A method in accordance with claim 1, further comprising automatically establishing, with an automated attendant system, a call connection to the first party.

5. A method in accordance with claim 4, wherein the automated attendant system comprises an automated interactive voice response system (IVRS).

6. A method in accordance with claim 1, further comprising providing the first party of the call with standard call structures.

7. A method in accordance with claim 3, further comprising providing at least one computer to be used for the automated attendant system or the voice recognition system.

8. A method in accordance with claim 1, further comprising performing voice recognition with a plurality of computers in parallel.

9. A method in accordance with claim 1, further comprising performing voice recognition using a multiple of processes on one computer in parallel.

10. A method in accordance with claim 1, further comprising performing voice recognition in a computer network system in parallel.

11. A method in accordance with claim 1, further comprising storing voice data from the call in at least a largely unchanged state.

12. A method in accordance with claim 1, wherein analyzing the call comprises performing voice recognition with information about the current call status being taken into account.

13. A method in accordance with claim 1, wherein analyzing the call comprises performing voice recognition that is tailored individually to a request for analysis.

14. A method in accordance with claim 1, wherein analyzing the call comprises performing voice recognition with at least one of dictation recognition, grammar recognition, single word recognition and keyword spotting.

15. A method in accordance with claim 14, wherein dictation recognition, grammar recognition, single word recognition and keyword spotting are used in parallel.

16. A method in accordance with claim 14, wherein voice recognition is performed repeatedly.

17. A method in accordance with claim 14, wherein voice recognition is performed with dynamic adjustment.

18. A method in accordance with claim 17, wherein the vocabulary for performing voice recognition is varied and/or adjusted.

19. A method in accordance with claim 17, further comprising classifying voice data from the call with keyword spotting as part of a first recognition step for the dynamic adjustment of the voice recognition.

20. A method in accordance with claim 19, further comprising reexamining the voice data as part of an additional recognition step by adding specific vocabulary.

21. A method in accordance with claim 20, further comprising iteratively performing additional recognition steps that are controlled by recognition probabilities.

22. A method in accordance with claim 1, further comprising extracting additional information by using the link.

23. A method in accordance with claim 22, wherein the additional information is extracted from at least one of the database system and expert system in order to dynamically control the voice recognition.

24. A method in accordance with claim 22, further comprising providing at least one of the result of analyzing the call and the additional information in a graphical and/or orthographical representation.

25. A method in accordance with claim 24, wherein at least one of the result of analyzing the voice data and the additional information is provided with time delay.

26. A method in accordance with claim 24, wherein at least one of the result of analyzing the voice data and the additional information is provided to the second party nearly synchronously.

27. A method in accordance with claim 26, wherein at least one of the result of analyzing the voice data and the additional information is provided to the second party during the call.

28. A method in accordance with claim 1, further comprising enabling the second party to at least partially control the voice recognition.

29. A method in accordance with claim 28, wherein enabling the second party comprises permitting the second party to load user profiles to facilitate voice recognition.

30. A method in accordance with claim 1, further comprising providing additional information from at least one of a database system and expert system to facilitate voice recognition.

31. A method in accordance with claim 1, further comprising storing the result of analyzing the call as text.

32. A method in accordance with claim 1, wherein the method is used in a call center.

33. A method in accordance with claim 1, further comprising integrating the method as part of a total program of a computer program.

34. A method in accordance with claim 1, further comprising integrating the method to train agents of a call center.

35. A method in accordance with claim 1, further comprising training the voice recognition system on the voice of at least one of the first party and the second party, wherein the second party is an agent of a call center.

36. A method in accordance with claim 35, further comprising increasing the recognition rate of the voice recognition system by having the agent repeat single words spoken by the first party, so that the voice recognition system can analyze the voice data of a trained voice.

37. A system for processing voice data from a call between a first human party and a second or more human parties, the system comprising:
an automated voice recognition system for analyzing voice data from the call to recognize and extract text from the voice data automatically, the voice recognition system being linkable with one or more devices to record the voice data; and
means for representing the recognized and extracted text to the second or more human parties, wherein the means for representing is connected directly or indirectly with the voice recognition system.

38. A system in accordance with claim 37, wherein the voice recognition system is connected with at least one automated attendant system.

39. A system in accordance with claim 38, wherein the voice recognition system is connected to a plurality of automated attendant systems.

40. A system in accordance with 38, wherein the at least one automated attendant system comprises a stationary or mobile phone.

41. A system in accordance with claim 38, wherein the at least one automated attendant system comprises an automated interactive voice response system (IVRS).

42. A system in accordance with claim 37, wherein the voice recognition system comprises one or a plurality of computers.

43. A system in accordance with claim 38, wherein the at least one automated attendant system comprises one or a plurality of computers.

44. A system in accordance with claim 42 or 43, wherein the plurality of computers are connected in the form of a network.

45. A system in accordance with claim 44, wherein the network comprises a client/server structure.

46. A computer program product with program code means that are stored on a computer-readable storage medium and suitable to execute a method in accordance with any one of claims 1 to 36 when executed on a computer.
